(19) United States
(12) Patent Application Publication
(10) Pub. No.: US 2013/0166767 A1
(43) Pub. Date: Jun. 27, 2013

(54) SYSTEMS AND METHODS FOR RAPID IMAGE DELIVERY AND MONITORING

(71) Applicant: General Electric Company, Schenectady, NY (US)

(72) Inventor: Christopher John Olivier, Park Ridge, NJ (US)

(73) Assignee: General Electric Company, Schenectady, NY (US)

(21) Appl. No.: 13/683,258

(22) Filed: Nov. 21, 2012

Related U.S. Application Data
(60) Provisional application No. 61/563,524, filed on Nov. 23, 2011.

(51) Int. Cl. H04L 29/06

(52) U.S. Cl. CPC H04L 65/60
USPC 709/231

(57) ABSTRACT

Certain examples provide systems and methods to prioritize and process image streaming from storage to display. Certain examples provide systems and methods to accelerate and improve diagnostic image processing and display. An example medical image streaming engine is configured to receive a request for image data, and, according to a data priority determination, extract the requested image data from a data storage and process the image data to provide processed image data for display. The example streaming engine is to process the image data to generate, based on downsampling, lossy encoding, decompression and upsampling, a first lossy pre-image for initial display and then to generate, based on lossless encoding and decompression, a lossless image for diagnostic display.

### RELATED APPLICATIONS

This patent claims priority to U.S. Provisional Application Ser. No. 61/563,524, entitled “Systems and Methods for Rapid Image Delivery and Monitoring,” which was filed on Nov. 23, 2011 and is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during and/or after surgery, medical personnel may access patient information, such as images of a patient's anatomy, that are stored in a medical information system. Radiologist and/or other clinicians may review stored images and/or other information, for example.

Using a PACS and/or other workstation, a clinician, such as a radiologist, may perform a variety of activities, such as an image reading, to facilitate a clinical workflow. A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools. For example, a radiologist or cardiologist typically looks into other systems such as laboratory information, electronic medical records, and healthcare information when reading examination results.

PACS were initially used as an information infrastructure supporting storage, distribution, and diagnostic reading of images acquired in the course of medical examinations. As PACS developed and became capable of accommodating vast volumes of information and its secure access, PACS began to expand into the information-oriented business and professional areas of diagnostic and general healthcare enterprises. For various reasons, including but not limited to a natural tendency of having one information technology (IT) department, one server room, and one data archive/backup for all departments in healthcare enterprise, as well as one desktop workstation used for all business day activities of any healthcare professional, PACS is considered as a platform for growing into a general IT solution for the majority of IT oriented services of healthcare enterprises.

Medical imaging devices now produce diagnostic images in a digital representation. The digital representation typically includes a two dimensional raster of the image equipped with a header including collateral information with respect to the image itself, patient demographics, imaging technology, and other data used for proper presentation and diagnostic interpretation of the image. Often, diagnostic images are grouped in series each series representing images that have some commonality and differ in one or more details. For example, images representing anatomical cross-sections of a human body substantially normal to its vertical axis and differing by their position on that axis from top (head) to bottom (feet) are grouped in so-called axial series. A single medical exam, often referred as a “study” or an “exam” typically includes one or more series of images, such as images exposed before and after injection of contrast material or images with different orientation or differing by any other relevant circumstance(s) of imaging procedure. The digital images are forwarded to specialized archives equipped with proper means for safe storage, search, access, and distribution of the images and collateral information for successful diagnostic interpretation.

Diagnostic physicians that read a study digitally via access to a PACS from a local workstation currently suffer from a significant problem associated with the speed of study opening and making studies available for review where the reading performance of some radiologists requires opening up to 30 magnetic resonance imaging (MRI) studies an hour. Currently, a significant portion of a physician's time is spent just opening the study at the local workstation. When a user is reading one study after another, a switch from a study just read to the next study to be read requires two mouse clicks (one to close the current study and one to open the next study via the physician worklist), introduces delay between those clicks necessary for the refresh of the study list, and an additional delay for loading the next study.

Secondly, current mechanisms for loading a study do not allow for negotiation between instances of a diagnostic viewer that are invoked at the same time and share network bandwidth and processing capability on the workstation trying to simultaneously downloading multiple studies and respond to a user interface reading the study. This causes all studies to load more slowly so that it takes proportionally longer for the first study to become ready for reading. Such an approach is especially detrimental for cases when the first study needs to be downloaded as fast as possible, for example, when reading mammography studies. Bottlenecks develop through inefficient use of available system resources, made worse by a lack of capture of current business and system intelligence.

### BRIEF SUMMARY

Certain examples provide systems and methods to prioritize and process image streaming from storage to display. Certain examples provide systems and methods to accelerate and improve diagnostic image processing and display.

Certain examples provide a medical image streaming pipeline system. The example system includes a streaming engine. The example streaming engine is configured to receive a request for image data, and, according to a data priority determination, extract the requested image data from a data storage and process the image data to provide processed image data for display. The example streaming engine is to process the image data to generate, based on downsampling, lossy encoding, decompression and upsampling, a first lossy pre-image for initial display and then to generate, based on lossless encoding and decompression, a lossless image for diagnostic display.

Certain examples provide a tangible computer readable storage medium including computer program instructions to be executed by a processor, the instructions, when executing, to implement a medical image streaming engine. The example streaming engine is configured to receive a request for image data, and, according to a data priority determination, extract the requested image data from a data storage and process the image data to provide processed image data for display. The example streaming engine is to process the image data to generate, based on downsampling, lossy encoding, decompression and upsampling, a first lossy pre-image for initial display and then to generate, based on lossless encoding and decompression, a lossless image for diagnostic display.

Certain examples provide a method of medical image streaming. The example method includes receiving a request for image data at a streaming engine. The example method includes, according to a data priority determination, extracting, via the streaming engine, the requested image data from a data storage. The example method includes processing the image data, via the streaming engine, to provide processed image data for display. In the example method, the processing includes processing the image data to generate, based on downsampling, lossy encoding, decompression and upsampling, a first lossy pre-image for initial display and then to generate, based on lossless encoding and decompression, a lossless image for diagnostic display.

### BRIEF DESCRIPTION OF SEVERAL VIEWS OF THE DRAWINGS

FIGS. 1-3 illustrate example healthcare or clinical information systems.

FIG. 4 is a block diagram of an example processor system that may be used to implement systems and methods described herein.

FIG. 5 illustrates an example viewer receiving images from a single streaming engine.

FIG. 6 depicts an example multiple streaming engine module.

FIG. 7 shows an example streaming engine deployed in a proxy model.

FIG. 8 depicts an example of a load balanced/high availability image streaming model.

FIG. 9 illustrates an example system to help achieve continuous maximum network throughput while maintaining fast reaction time to changes in what is being requested.

FIG. 10 shows an example data pipeline in a componentized pipeline architecture.

FIG. 11 depicts an example componentized pipeline architecture.

FIG. 12 shows an example logical viewer simulator including a series of images, each associated with a serial number.

FIG. 13 provides further examples of image priority based on context, study, collection, etc.

FIG. 14 depicts an example image architecture to facilitate image input, processing, prioritization, and output.

FIG. 15 illustrates an example using fast lossy compression to generate a lossy pre-image to send first, followed by one or more lossless images.

FIG. 16 illustrates an example pipeline construction robot.

FIG. 17 depicts a fully constructed pipeline and data flow of image data from source filters to render filter.

FIG. 18 shows an example filter graph.

FIG. 19 illustrates an example system showing data communication and channels between a server, a viewer, and a plurality of streaming adapters.

FIG. 20 shows an example including a control channel communicating information from a viewer adapter application programming interface to a Logical Viewer Simulator on a server.

FIG. 21 provides an example of a complete system and flow of command channel and data.

FIG. 22 illustrates an example single viewer adapter instance with multiple streaming servers.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

Certain examples provide a streaming pipeline built around 1) performance monitoring and improvement, 2) improvement/optimization of time to view first image, 3) supporting algorithms, and 4) compression/decompression strategies. Certain examples provide a componentized pipeline architecture and data priority determination/handling mechanism combined with fast lossy image compression to more quickly provide a first and subsequent images to a user via a viewer (e.g., a web-based viewer such as with GE PACS-IW®).

Certain examples provide a componentized pipeline that allows extendibility via a well-defined abstract filter pin interface in a scalable architecture.

Certain examples help to provide an image to a radiologist as quickly as possible while helping to accommodate issues such as problems with network-based image delivery, variability in remote systems, prioritization of image loading, sufficient quality standards for image review, etc. Thus, certain examples help provide a fast response time to first image, performance monitoring for reliability and real-time improvement, improved calculation of data priority and pipeline management, etc.

In certain examples, rather than performing a lossless compression, then providing a portion of the lossless compression followed by the rest of the lossless compression, a quick lossy pre-image is generated and transmitted, followed by a lossless image.

In certain examples, binary data is transferred from server to viewer (image data, metadata, digital imaging and communications in medicine (DICOM) data, etc.). An order of image loading is determined for the viewer by examining surrounding images, a direction of scrolling through images, etc., to load images in a more “intelligent” or predictive order.

Certain embodiments relate to system resource and process awareness. Certain embodiments help provide awareness to a user from both a user interface and a client perspective regarding status of a patient and the patient's exam as well as a status of system resources. Thus, the user can review available system resources and can make adjustments regarding pending processes in a workflow. For example, a user may not have printer access to generate a report at a first workstation and may need to log in to another system to generate the report including discharge instructions for a patient and/or feedback for a referring physician. As another example, a certain component or node in an image processing pipeline may be slower than other components or nodes and/or may be experiencing a bottleneck that impacts workflow execution. A user can see, based on system resource and utilization information, when an image is loading slowly and can move on to another task, for example. In certain embodiments, system intelligence can be combined with business intelligence to provide instantaneous vital signs for the organization from whatever desired perspective. Such a combination of system and business intelligence can be used to inform the system and/or user regarding progress of a workflow, status of reporting physicians, how quickly physicians are reacting to information and recommendations, etc. A combination of system and business intelligence can be used to evaluate whether physicians are taking action based on information and recommendations from the system, for example.

Thus, certain embodiments provide adaptability and dynamic re-evaluation of system conditions and priorities, enabling the system to react and try different compensating strategies to adapt to changing conditions and priorities.

Certain embodiments relate to reading and interpretation of diagnostic imaging studies, stored in their digital representation and searched, retrieved, and read using a PACS and/or other clinical system. In certain embodiments, images can be stored on a centralized server while reading is performed from one or more remote workstations connected to the server via electronic information links. Remote viewing creates a certain latency between a request for image(s) for diagnostic reading and availability of the images on a local workstation for navigation and reading. Additionally, a single server often provides images for a plurality of workstations that can be connected through electronic links with different bandwidths. Differing bandwidth can create a problem with respect to balanced splitting of the transmitting capacity of the central server between multiple clients. Further, diagnostic images can be stored in one or more advanced compression formats allowing for transmission of a lossy image representation that is continuously improving until finally reaching a lossless, more exact representation. In addition, a number of images produced per standard medical examination continues to grow, reaching 2,500 to 4,000 images per one typical computed tomography (CT) exam compared to 50 images per one exam a decade ago.

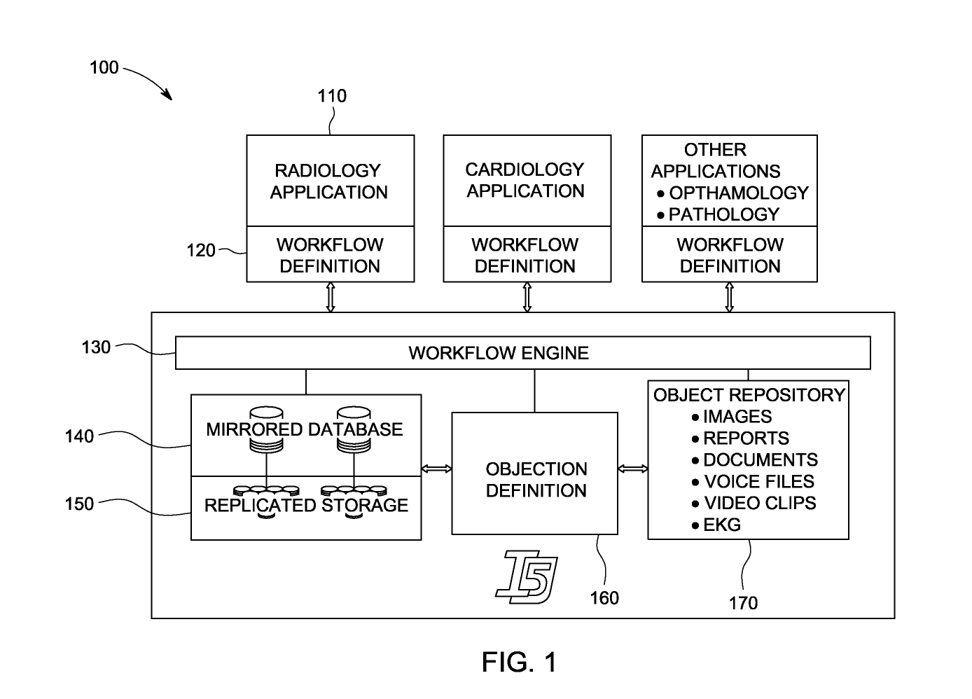

Certain embodiments provide an information system for a healthcare enterprise including a PACS system for radiology and/or other subspecialty system as demonstrated by the business and application diagram in FIG. 1. The system 100 of FIG. 1 includes a clinical application 110, such as a radiology, cardiology, ophthalmology, pathology, and/or application. The system 100 also includes a workflow definition 120 for each application 110. The workflow definitions 120 communicate with a workflow engine 130. The workflow engine 130 is in communication with a mirrored database 140, object definitions 60, and an object repository 170. The mirrored database 140 is in communication with a replicated storage 150. The object repository 170 includes data such as images, reports, documents, voice files, video clips, electrocardiogram (EKG) information, etc.

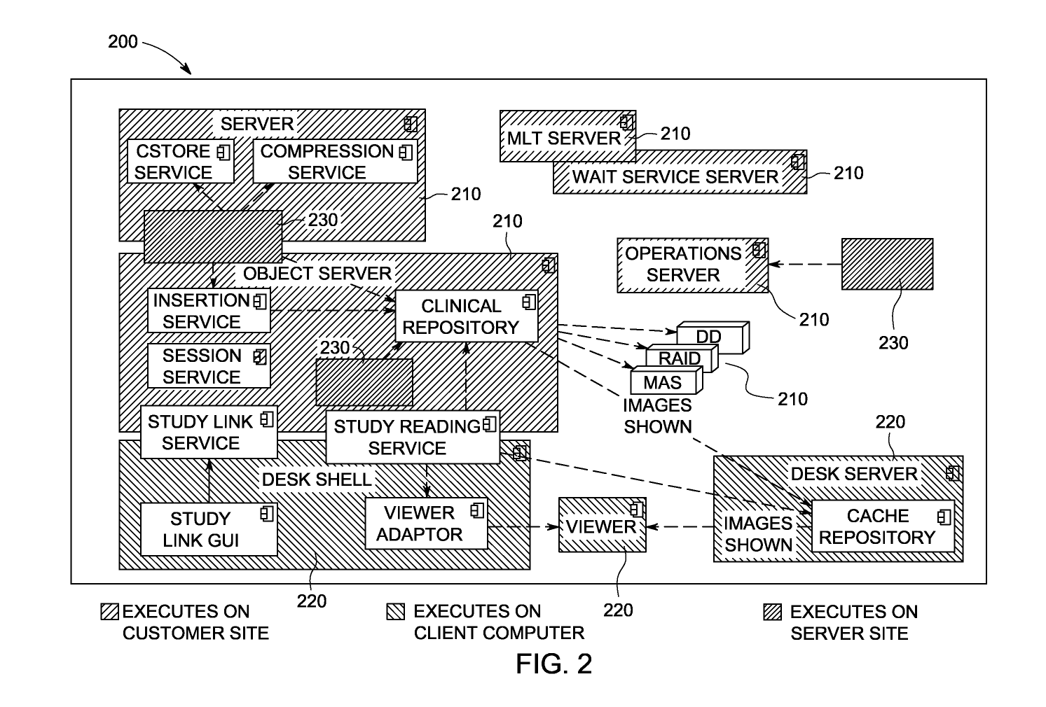

An embodiment of an information system that delivers application and business goals is presented in FIG. 2. The specific arrangement and contents of the assemblies constituting this embodiment bears sufficient novelty and constitute part of certain embodiments of the present invention. The information system 200 of FIG. 2 demonstrates services divided among a service site 230, a customer site 210, and a client computer 220. For example, a DICOM Server, HL7 Server, Web Services Server, Operations Server, database and other storage, an Object Server, and a Clinical Repository execute on a customer site 210. A Desk Shell, a Viewer, and a Desk Server execute on a client computer 220. A DICOM Controller, Compiler, and the like execute on a service site 230. Thus, operational and data workflow may be divided, and only a small display workload is placed on the client computer 220, for example.

Certain embodiments provide an architecture and framework for a variety of clinical applications. The framework can include front-end components including but not limited to a Graphical User Interface (“GUI”) and can be a thin client and/or thick client system to varying degree, which some or all applications and processing running on a client workstation, on a server, and/or running partially on a client workstation and partially on a server, for example.

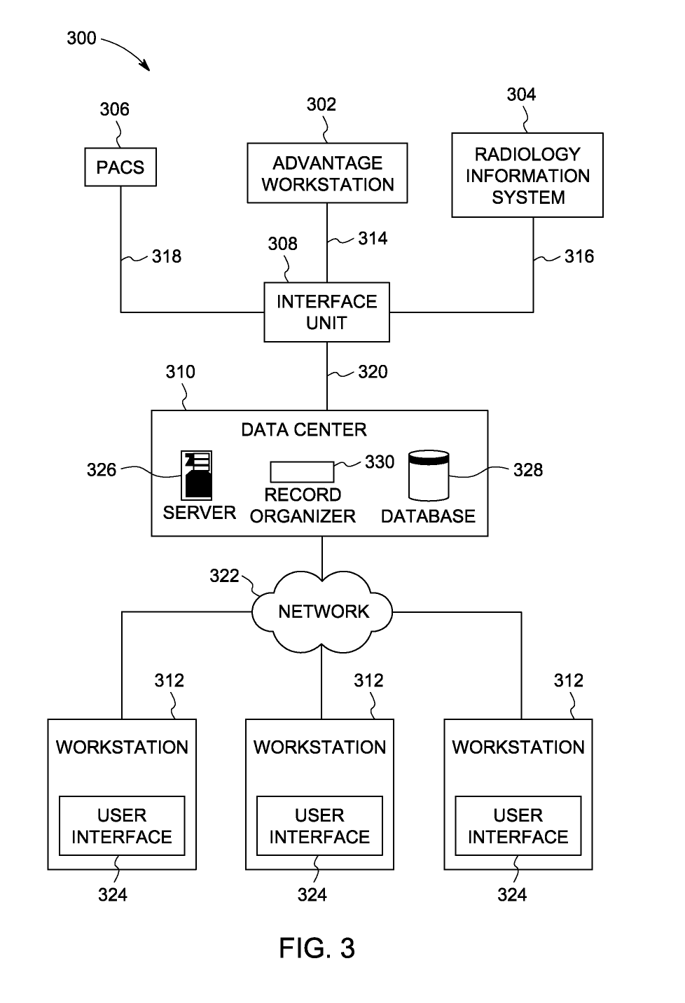

FIG. 3 shows a block diagram of an example clinical information system 300 capable of implementing the example methods and systems described herein. The example clinical information system 300 includes a hospital information system (“HIS”) 302, a radiology information system (“RIS”) 304, a picture archiving and communication system (“PACS”) 306, an interface unit 308, a data center 310, and a plurality of workstations 312. In the illustrated example, the HIS 302, the RIS 304, and the PACS 306 are housed in a healthcare facility and locally archived. However, in other implementations, the HIS 302, the RIS 304, and/or the PACS 306 may be housed one or more other suitable locations. In certain implementations, one or more of the PACS 306, RIS 304, HIS 302, etc., can be implemented remotely via a thin client and/or downloadable software solution. Furthermore, one or more components of the clinical information system 300 may be combined and/or implemented together. For example, the RIS 304 and/or the PACS 306 may be integrated with the HIS 302; the PACS 306 may be integrated with the RIS 304; and/or the three example information systems 302, 304, and/or 306 may be integrated together. In other example implementations, the clinical information system 300 includes a subset of the illustrated information systems 302, 304, and/or 306. For example, the clinical information system 300 may include only one or two of the HIS 302, the RIS 304, and/or the PACS 306. Preferably, information (e.g., scheduling, test results, observations, diagnosis, etc.) is entered into the HIS 302, the RIS 304, and/or the PACS 306 by healthcare practitioners (e.g., radiologists, physicians, and/or technicians) before and/or after patient examination.

The HIS 302 stores medical information such as clinical reports, patient information, and/or administrative information received from, for example, personnel at a hospital, clinic, and/or a physician's office. The RIS 304 stores information such as, for example, radiology reports, messages, warnings, alerts, patient scheduling information, patient demographic data, patient tracking information, and/or physician and patient status monitors. Additionally, the RIS 304 enables exam order entry (e.g., ordering an x-ray of a patient) and image and film tracking (e.g., tracking identities of one or more people that have checked out a film). In some examples, information in the RIS 304 is formatted according to the HL-7 (Health Level Seven) clinical communication protocol.

The PACS 306 stores medical images (e.g., x-rays, scans, three-dimensional renderings, etc.) as, for example, digital images in a database or registry. In some examples, the medical images are stored in the PACS 306 using the Digital Imaging and Communications in Medicine (“DICOM”) format. Images are stored in the PACS 306 by healthcare practitioners (e.g., imaging technicians, physicians, radiologists) after a medical imaging of a patient and/or are automatically transmitted from medical imaging devices to the PACS 306 for storage. In some examples, the PACS 306 may also include a display device and/or viewing workstation to enable a healthcare practitioner to communicate with the PACS 306.

The interface unit 308 includes a hospital information system interface connection 314, a radiology information system interface connection 316, a PACS interface connection 318, and a data center interface connection 320. The interface unit 308 facilities communication among the HIS 302, the RIS 304, the PACS 306, and/or the data center 310. The interface connections 314, 316, 318, and 320 may be implemented by, for example, a Wide Area Network (“WAN”) such as a private network or the Internet. Accordingly, the interface unit 308 includes one or more communication components such as, for example, an Ethernet device, an asynchronous transfer mode (“ATM”) device, an 802.11 device, a DSL modem, a cable modem, a cellular modem, etc. In turn, the data center 310 communicates with the plurality of workstations 312, via a network 322, implemented at a plurality of locations (e.g., a hospital, clinic, doctor's office, other medical office, or terminal, etc.). The network 322 is implemented by, for example, the Internet, an intranet, a private network, a wired or wireless Local Area Network, and/or a wired or wireless Wide Area Network. In some examples, the interface unit 308 also includes a broker (e.g., a Mitra Imaging's PACS Broker) to allow medical information and medical images to be transmitted together and stored together.

In operation, the interface unit 308 receives images, medical reports, administrative information, and/or other clinical information from the information systems 302, 304, 306 via the interface connections 314, 316, 318. If necessary (e.g., when different formats of the received information are incompatible), the interface unit 308 translates or reformats (e.g., into Structured Query Language (“SQL”) or standard text) the medical information, such as medical reports, to be properly stored at the data center 310. Preferably, the reformatted medical information may be transmitted using a transmission protocol to enable different medical information to share common identification elements, such as a patient name or social security number. Next, the interface unit 308 transmits the medical information to the data center 310 via the data center interface connection 320. Finally, medical information is stored in the data center 310 in, for example, the DICOM format, which enables medical images and corresponding medical information to be transmitted and stored together.

The medical information is later viewable and easily retrievable at one or more of the workstations 312 (e.g., by their common identification element, such as a patient name or record number). The workstations 312 may be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. The workstations 312 receive commands and/or other input from a user via, for example, a keyboard, mouse, track ball, microphone, etc. As shown in FIG. 3, the workstations 312 are connected to the network 322 and, thus, can communicate with each other, the data center 310, and/or any other device coupled to the network 322. The workstations 312 are capable of implementing a user interface 324 to enable a healthcare practitioner to interact with the clinical information system 300. For example, in response to a request from a physician, the user interface 324 presents a patient medical history. Additionally, the user interface 324 includes one or more options related to the example methods and apparatus described herein to organize such a medical history using classification and severity parameters.

The example data center 310 of FIG. 3 is an archive to store information such as, for example, images, data, medical reports, and/or, more generally, patient medical records. In addition, the data center 310 may also serve as a central conduit to information located at other sources such as, for example, local archives, hospital information systems/radiology information systems (e.g., the HIS 302 and/or the RIS 304), or medical imaging/storage systems (e.g., the PACS 306 and/or connected imaging modalities). That is, the data center 310 may store links or indicators (e.g., identification numbers, patient names, or record numbers) to information. In the illustrated example, the data center 310 is managed by an application server provider (“ASP”) and is located in a centralized location that may be accessed by a plurality of systems and facilities (e.g., hospitals, clinics, doctor's offices, other medical offices, and/or terminals). In some examples, the data center 310 may be spatially distant from the HIS 302, the RIS 304, and/or the PACS 306 (e.g., at General Electric® headquarters).

The example data center 310 of FIG. 3 includes a server 326, a database 328, and a record organizer 330. The server 326 receives, processes, and conveys information to and from the components of the clinical information system 300. The database 328 stores the medical information described herein and provides access thereto. The example record organizer 330 of FIG. 3 manages patient medical histories, for example. The record organizer 330 can also assist in procedure scheduling, for example.

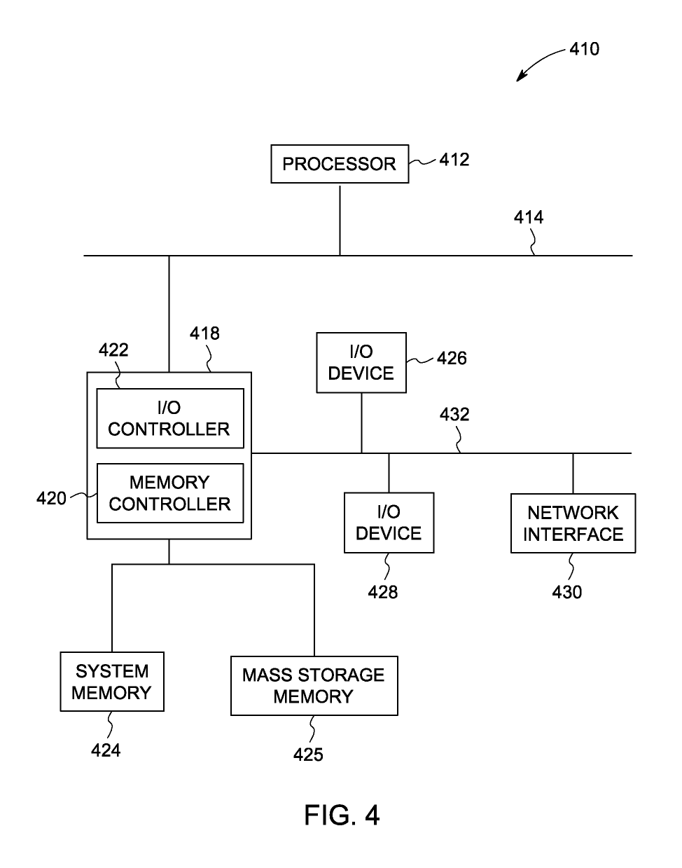

FIG. 4 is a block diagram of an example processor system 410 that may be used to implement systems and methods described herein. As shown in FIG. 4, the processor system 410 includes a processor 412 that is coupled to an interconnection bus 414. The processor 412 may be any suitable processor, processing unit, or microprocessor, for example. Although not shown in FIG. 4, the system 410 may be a multi-processor system and, thus, may include one or more additional processors that are identical or similar to the processor 412 and that are communicatively coupled to the interconnection bus 414.

The processor 412 of FIG. 4 is coupled to a chipset 418, which includes a memory controller 420 and an input/output (“I/O”) controller 422. As is well known, a chipset typically provides I/O and memory management functions as well as a plurality of general purpose and/or special purpose registers, timers, etc. that are accessible or used by one or more processors coupled to the chipset 418. The memory controller 420 performs functions that enable the processor 412 (or processors if there are multiple processors) to access a system memory 424 and a mass storage memory 425.

The system memory 424 may include any desired type of volatile and/or non-volatile memory such as, for example, static random access memory (SRAM), dynamic random access memory (DRAM), flash memory, read-only memory (ROM), etc. The mass storage memory 425 may include any desired type of mass storage device including hard disk drives, optical drives, tape storage devices, etc.

The I/O controller 422 performs functions that enable the processor 412 to communicate with peripheral input/output (“I/O”) devices 426 and 428 and a network interface 430 via an I/O bus 432. The I/O devices 426 and 428 may be any desired type of I/O device such as, for example, a keyboard, a video display or monitor, a mouse, etc. The network interface 430 may be, for example, an Ethernet device, an asynchronous transfer mode (“ATM”) device, an 802.11 device, a DSL modem, a cable modem, a cellular modem, etc. that enables the processor system 410 to communicate with another processor system.

While the memory controller 420 and the I/O controller 422 are depicted in FIG. 4 as separate blocks within the chipset 418, the functions performed by these blocks may be integrated within a single semiconductor circuit or may be implemented using two or more separate integrated circuits.

Certain examples provide one or more components or engines to intelligently stream or pass images through to a viewer, for example. In certain examples, a unified viewer workspace for radiologists and clinicians brings together capabilities with innovative differentiators that drive optimal performance through connected, intelligent workflows. The unified viewer workspace enables radiologist performance and efficiency, improved communication between the radiologist and other clinicians, and image sharing between and across organizations, reducing cost and improving care.

The unified imaging viewer displays medical images, including mammograms and other x-ray, computed tomography (CT), magnetic resonance (MR), ultrasound, and/or other images, and non-image data from various sources in a common workspace. Additionally, the viewer can be used to create, update annotations, process and create imaging models, communicate, within a system and/or across computer networks at distributed locations.

In certain examples, the unified viewer implements smart hanging protocols, intelligent fetching of patient data from within and outside a picture archiving and communication system (PACS) and/or other vendor neutral archive (VNA). In certain examples, the unified viewer supports image exchange functions and implements high performing streaming, as well as an ability to read across disparate PACS without importing data. The unified viewer serves as a “multi-ology” viewer, for example.

In certain examples, the viewer can facilitate image viewing and exchange. For example, DICOM images can be viewed from a patient's longitudinal patient record in a clinical data repository, vendor neutral archive, etc. A DICOM viewer can be provided across multiple PACS databases with display of current/priors in the same framework, auto-fetching, etc.

In certain examples, the viewer facilitates WebSockets-based DICOM image streaming. For example, an image's original format can be maintained through retrieval and display via the viewer. Certain examples provide programmable workstation functions using a WebSockets transport layer. Certain examples provide JavaScript remoting function translation over WebSockets.

In certain examples, a study overview can be created based on image information from an archive as well as request tokens for the streaming engine. A launch study response can be sent with the study overview. A client receives the launch study response and uses tokens in the study overview to generate one or more requests for image and/or non-image data. The client sends a request for images and/or non-image objects based on tokens in the request. The streaming engine receives the request and generates a corresponding request for images/non-image objects to a data archive, for example. The archive provides a response to the streaming engine including the requested images and/or non-image data. The streaming engine provides a response 350 including the requested images/non-image data. Images can be rendered based on received grayscale presentation state (GSPS) and pixel data. Rendered image(s) and associated non-image data are then accessible at the client, for example.

An example image streaming protocol includes receiving a request for image data from a web browser (e.g., a request to open a study). In certain examples, an image streaming engine allows transcoding of image data on the server (e.g., JPEG2000 to JPEG, JPEG to RAW, RAW to JPEG, etc) as well as requesting resealed or region-of-interests of the original image data. This allows the client to request images specifically catered to a situation (e.g., low bandwidth, high bandwidth, progressive display, etc). In an example, a default is provided for the client to request a 60% quality lossy compressed JPEG of the original image, and then to request the raw data afterwards. This allows the image to be displayed very quickly to the client and while retrieving the lossless (raw) data in the pipe for diagnostic quality image display in follow-up.

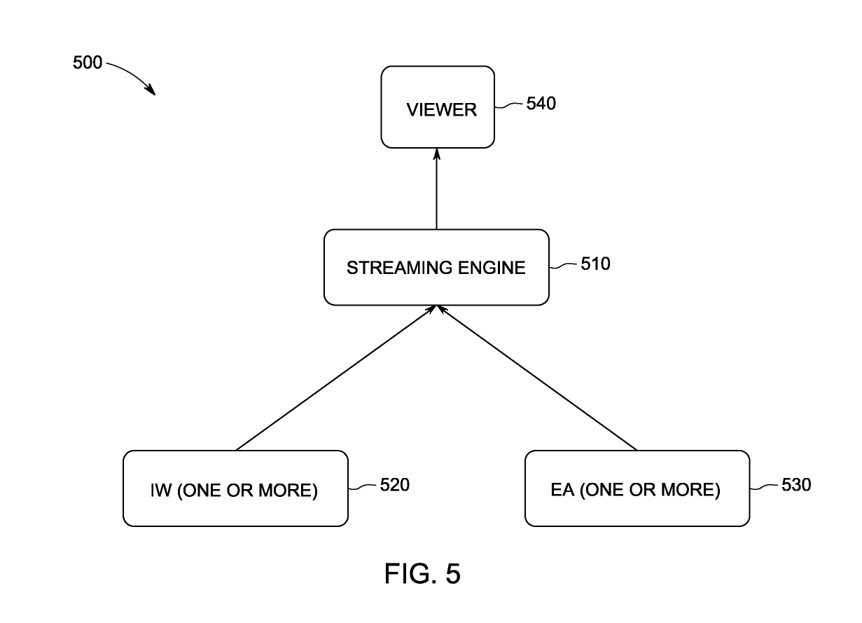

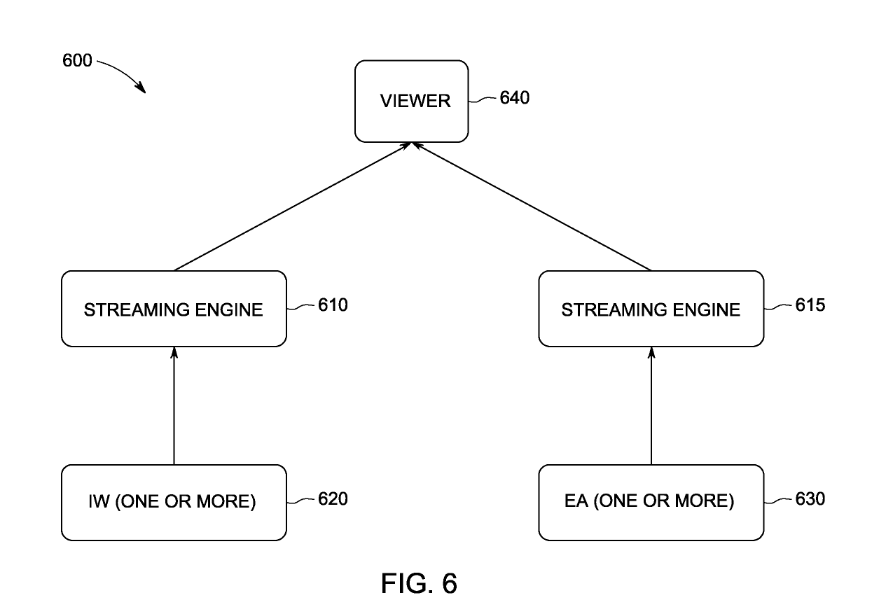

As illustrated in the example 500 of FIG. 5, a viewer 540 receives images from a single streaming engine 510, which collects the images from one or imaging workstations (IW) 520, enterprise archives (EA) 530, etc. FIG. 6 depicts a multiple streaming engine module 600 in which one or more IWs 620 provide images to a viewer 640 through a first streamer 610 and one or more EAs 630 provide images to the viewer 640 through another streamer 615.

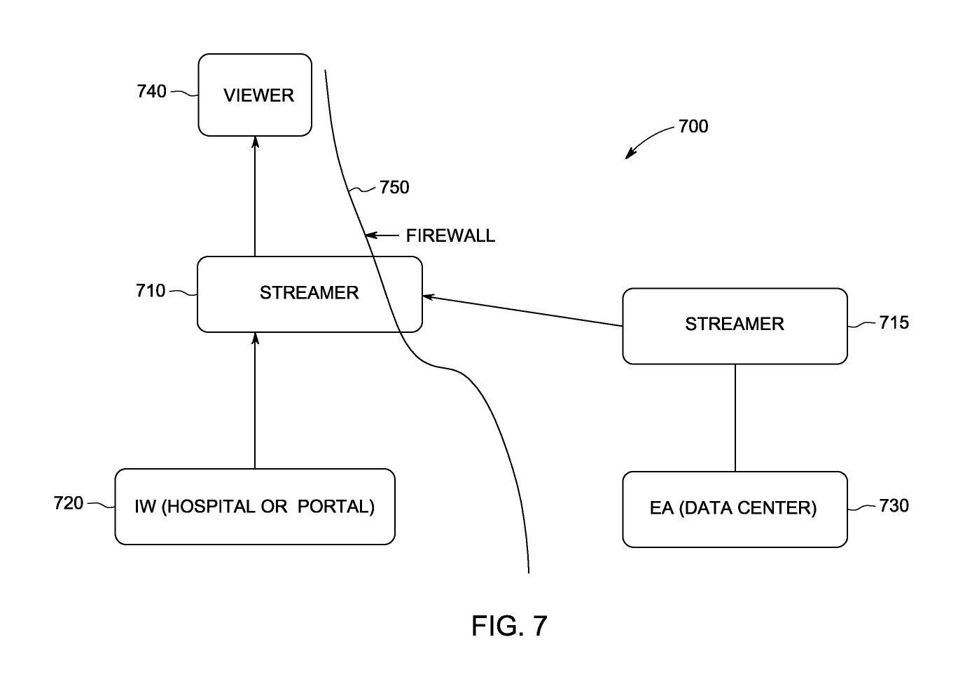

As shown in FIG. 7, a streaming engine 710, 715 can be deployed in a proxy model 700 wherein one or more streaming engines 710, 715 communicate with a viewer 740. In the example of FIG. 7, a first streaming engine 710 provides IW content 720 (e.g., from a hospital or portal) to the viewer 740, and a firewall 750 regulates communication between the first streamer 710 and a second streamer 715 which is connected to an EA data center 730.

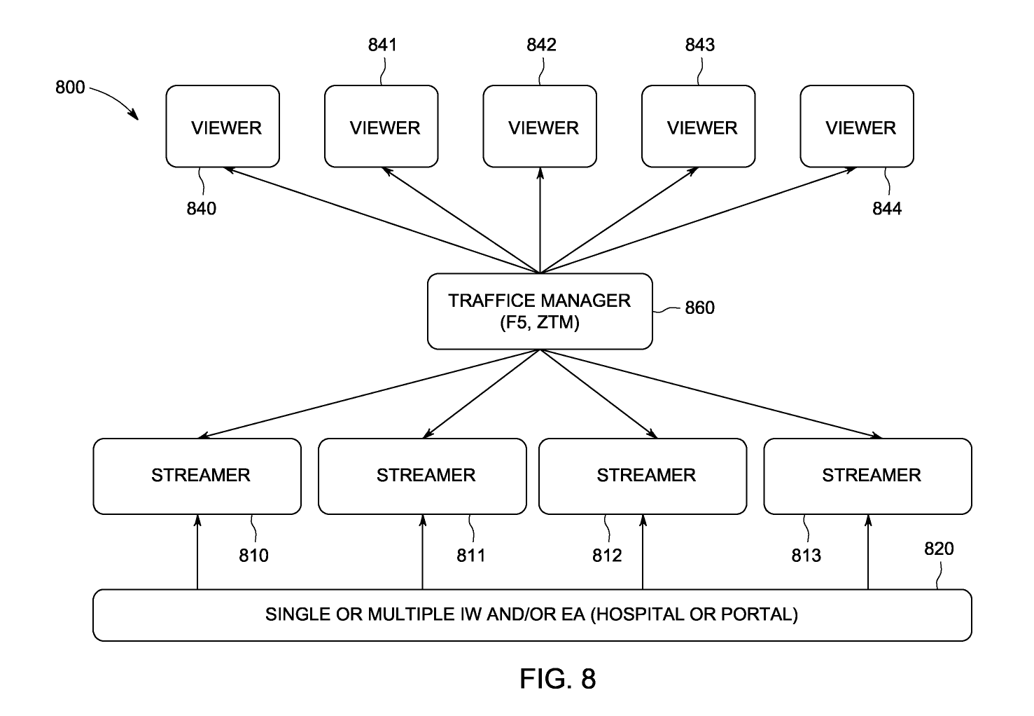

FIG. 8 provides an example of a load balanced/high availability image streaming model. The system 800 of FIG. 8 includes a traffic manager 860 (e.g., an F5 Networks™ BIG-IP Traffic Manager, Zeus Traffic Manager (ZTM), etc.) between several viewers 840-844, several streaming engines 810-813, and one or more IWs and/or EAs 820, for example.

In certain examples the streaming engine(s), IW(s), EA(s), etc., can be provided in a public and/or private cloud.

Certain examples use Internet Information Service and provide reliability, auto-restart, lack of dependency on network failures, etc. Certain examples employ a two channel mechanism—one control channel sends messages to web server and a second channel pulls in the data. The control channel is only open for message, while the data channel is kept open for data transmission, for example.

Certain examples provide image server and web server channels to a viewer.

Certain examples provide a componentized pipeline architecture (CPA) (e.g., built incrementally from source to renderer removing dependency on database architecture). The componentized architecture constructs an image data processing pipeline as far as it can without new instructions/information and then will ask/await for new instruction/information when it reaches a stopping point. This helps with speed for the first image delivery. The pipeline is already working on the first image as the other images are being received into the pipeline.

In certain examples, the pipeline may not initially know in what format the file is provide, so, when the architecture determines the file format, a processing robot is informed, and the robot determines how the pipeline should be constructed based on the file format (e.g., go from jpeg to progressive jpeg2000).

Certain examples determine data priority via a logical viewer simulator (LVS). For example, the LVS can calculate a priority based on a visual distance (e.g., how far the image is from the visible image), position (e.g., serial, sequence, or reference number), and image collection. A processing server can recalculate priority based on a change in visible image without sending any other information (e.g., quicker, with less lag).

In certain examples, a “glass” or set of images (e.g., a set of four images in a four blocker) can be provided, and, while a first glass is being displayed, a next glass is loaded.

Certain examples provide a data priority mechanism (e.g., pipeline) through which a low quality image (e.g., 10 k of 100 k for each image) is first sent, and sending of one image is interrupted if the user switches to viewing another image. Image(s) already farther down the pipeline still follow priority rules regardless of how much data may have already been downloaded, for example.

In certain examples, a priority engine talks to pins and finds pins with a highest priority and tells those pins or data inputs to send a chunk of their data. A prioritized flow of data is established through the pipeline, and where the data is flowing next depends on a global priority object. Priority can change regardless of where the previous priority data was in the pipeline.

In certain examples, fast lossy JPEG2000 compression is provided. A lossy pre-image is generated to send first, followed with lossless imagery. First a lossy pass and then a lossless pass are performed (versus a bit of the lossless compression followed by the rest of the lossless compression).

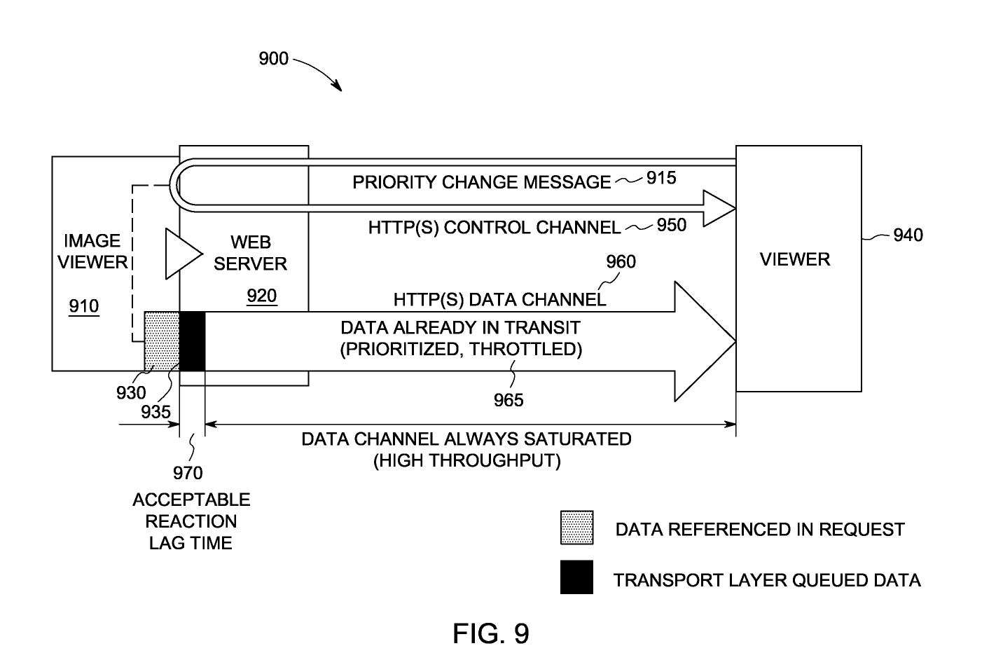

FIG. 9 illustrates an example system 900 to help achieve continuous maximum network throughput while maintaining fast reaction time to changes in what is being requested (e.g., user scrolls to a different image). A web server 920 (e.g., a COTS web server) provides an enterprise class web server that can handle security/encryption, load balancing, health monitoring, and application partitioning for reliability through configuration. The streaming image server 910 plugs directly into the request processing pipeline 965 of the web server 920 at a low level to provide more precise control over the network streams. Regardless of network conditions or bandwidths, responsiveness of image delivery to a viewer 940 can be improved. In certain examples, a protocol transport layer utilizes HTTP based protocols to integrate with customer and Internet infrastructure.

In the system of FIG. 9, the web server 920 provides secure HTTP (HTTPS) channels 950, 960, and the image server 910 plugs into the web server 920 to handle PACS requests and to serve continuous image data, for example.

As shown in the example of FIG. 9, an HTTP(S) data channel 960 provides a high throughput, saturated data channel or pipeline from the image server 910 to the viewer 940 via the web server 920. The data channel 960 includes a stream of prioritized, throttled data 965 in transit from the image server 910 to the viewer 940 via the web server 920. The HTTP(S) control channel 950 facilitates exchange of a priority change message 915 between the viewer 940 and web server 920 (and image server 910). Based on input and/or other instruction from the viewer 940, an image and/or other data priority can be adjusted, for example, and that priority is reflected by the web server 920 in the data stream 965 in the data channel 960.

As demonstrated in the example of FIG. 9, data 930 is requested from the image server 910 to be displayed at the viewer 940. A transport layer of the web server 920 and data delivery channel 960 is used to queue the requested data 935. A lag time or delay 970 is maintained by the web server 920 to remain within an acceptable limit. Thus, data can be prioritized and throttled by the web server 920 based on an indication of priority from the viewer such as an acceptable delay keeps the data channel 960 saturated at high throughput to provide image data for display via the viewer 940.

Thus, as demonstrated in FIG. 9, using a two channel mechanism, the control channel 950 sends messages to the web server 920, and the data channel 960 pulls in the data. In certain examples, the control channel 950 is only open for messages, while the data channel 960 is kept open for data transmission.

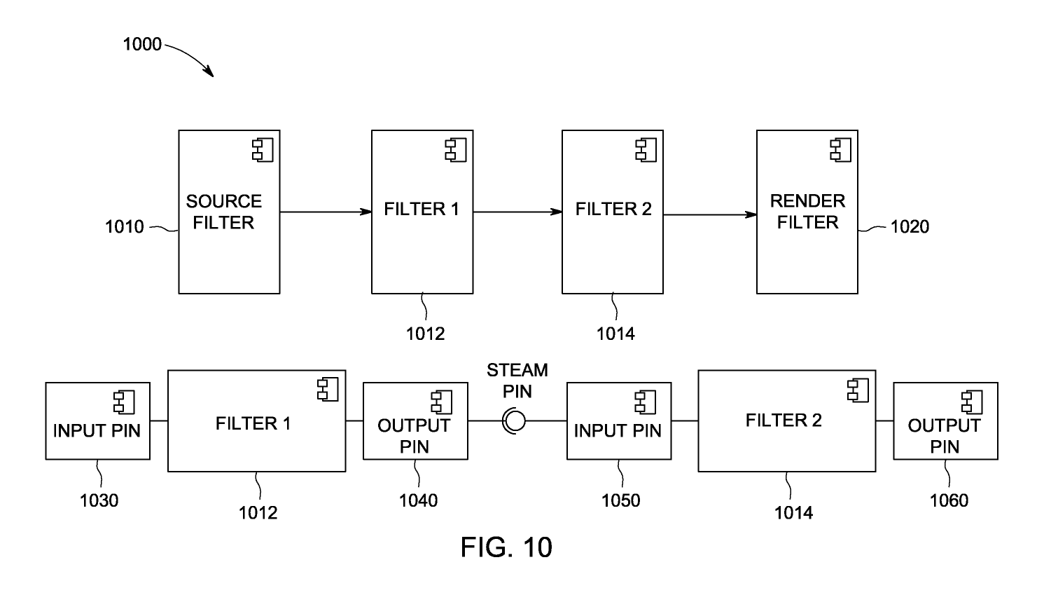

FIG. 10 shows an example data pipeline 1000 in a componentized pipeline architecture. The data pipeline 1000 is a logical path by which pixel (and/or non-image object) data moves through the system. The data can be in incremental packets (e.g., for incremental quality layers of an image or image region of interest, etc.), or an image or object from storage as a whole. The pipeline is constructed of “filter components” 1010, 1012, 1014, 10120 connected by “pins” (e.g., input pins 1030, 1050 and output pins 1040, 1060) through which the data flows. The filters 1010, 1012, 1014, 1020 operate on the data received from input pins 1030, 1050, and the output pins 1040, 1060 transfer the data and/or export an interface by which the data can be transferred. For example, using the pipelined architecture 1000, a source filter 1010 can provide filter input for two filter stages 1012, 1014. Using the filters 1010, 1012, 1014, 1020, image pixel data coming in on the input pins 1030, 1050 can be filtered, rendered for display, and streamed via the output pins 1040, 1060.

A “pin” is a logical object that is to pass data through to a next filter in a pipeline. While the LVS (Logical Viewer Simulator) along with its priority rules is responsible for determining what the highest priority item is for each filter to process next, the pin does the actual transfer and is also responsible for handling how much of one or more image sources (e.g., in the case of multi-component compression) per operation.

In certain examples, the source filter 1010 acts as the “source” for the image/NIO data in whatever form (compressed or otherwise) it is stored (e.g., a file on disk or in a disk cache). The source filter 1010 serves as the starting point for data flow. Whether any operation is performed on the data before it is “pushed” out its output pin 11040, 1050 depends on the characteristics and requirements of the source filter 1050 and the needs of the next filter 1012, 1014, 1020 in the pipeline. Data is passed via the source filter's output pin.

Pass-thru filters 1012, 1014 perform some operation on data which passes from their input pins 1030, 1050 to their output pins 1040, 1060. Operations can include changing the color space or planar configuration of the image data, compression, decompression, 3D rendering, or whatever transformation may be involved to efficiently receive the image pixel at the render filter 1020.

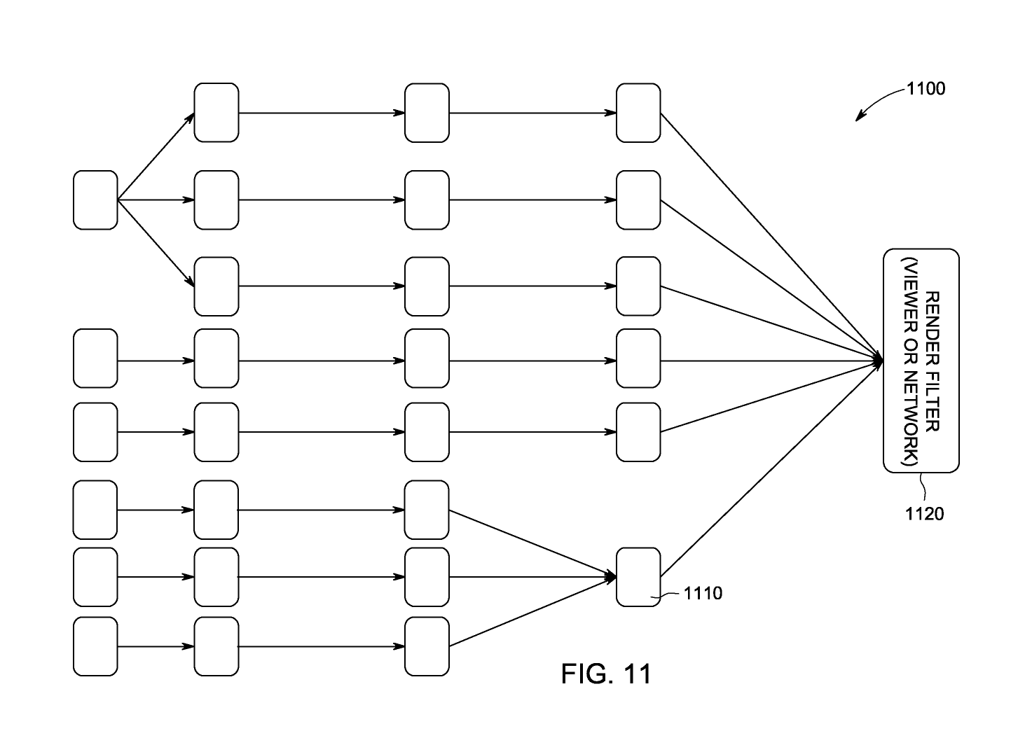

In certain examples, the render filter 1020 does not necessarily “render” an image onto a visual device. Rather, the render filter 1020 may be designated as a “final destination” in an imaging pipeline at which the data might be rendered to a display (e.g., via a viewing application), passed to a viewer as a set of legitimate image pixels, etc. Connections between filter graphs (for example, across a network) can be achieved by connecting a render filter of one graph to a source filter of another graph (e.g., network renderer for graph 1 to network source filter of graph 2), resulting in an extended filter graph comprised of two or more independent filter graphs, as shown, for example, in FIG. 11.

For example, FIG. 11 depicts another view of example componentized pipeline architecture 1100 including a plurality of in-line, converging, and diverging elements feeding in to a render filter for output to a viewer or network. In FIG. 11, the system 1100 handles in-line, converging, and diverging data and priorities, for example. A plurality of filter elements 1110 feeds into a render filter 1120 to provide rendered image pixel data to an image viewer or network. The render filter 1120 can prioritize and process the data from the plurality of filter modules 1110. Each filter module 1110 may be similar to the modules described with respect to FIG. 10, for example.

As shown in FIGS. 10 and 11, a componentized pipeline architecture (CPA) can be built incrementally from source to renderer. The componentized architecture constructs an image data processing pipeline as far as it can without new instructions/information and then asks/waits for new instruction/information when it reaches a stopping point. This helps with speed for the first image delivery. The pipeline is already working on the first image as the other images are being received into the pipeline.

In certain examples, the pipeline may not initially know in what format the file is provide, so, when the architecture determines the file format, a processing robot is informed, and the robot determines how the pipeline should be constructed based on the file format (e.g., go from jpeg to progressive jpeg2000).

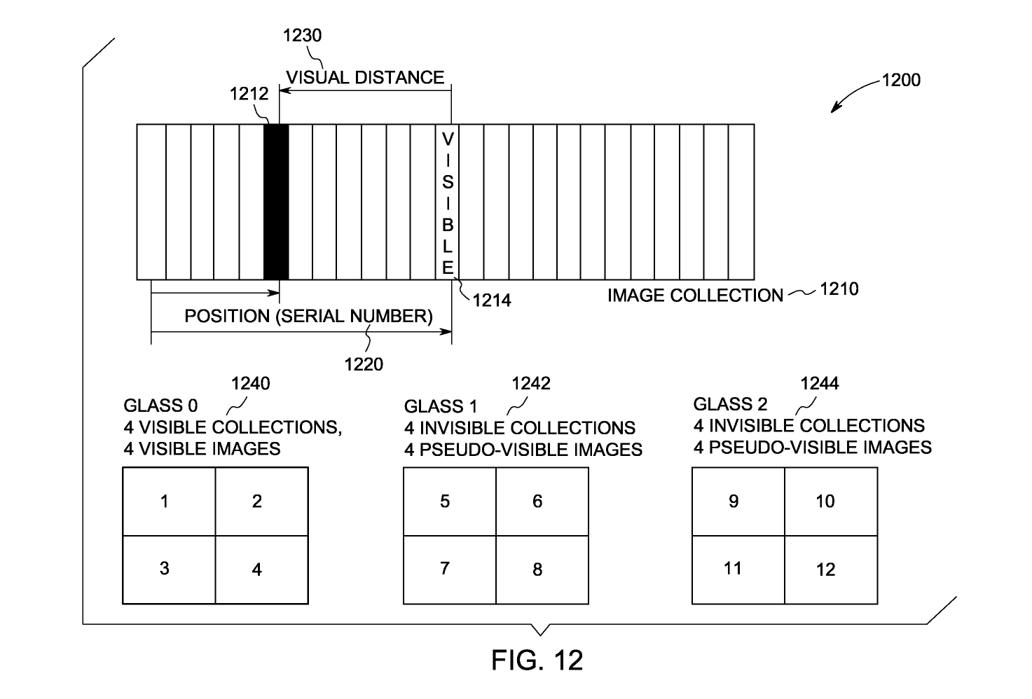

FIG. 12 shows an example LVS 1200 including a series of images 1210, each image associated with a serial number indicative of image position 1220. Based on a visual distance 1230 and image position 1220 of a selected image 1212 with respect to an image currently visible 1214 via an image viewer, an image transmission/viewing priority can be determined for one or more image streams, image glasses, etc.

Within an image collection 1210, individual images generally inherit their properties from a state of the image collection 1210 itself, along with additional priority (-ies) calculated by an image's position within the image collection 1210 relative to visible images 1214 within the image collection 1210.

Serial number 1220 represents the order of an image within the image collection 1210. In certain examples, this is the lowest priority modifier of an image. An example workflow scenario is that for all other priority-affecting parameters being equal, images should tend to load in a fashion from beginning-to-end within an image collection (be it partial quality pass or a cine pass, for example). This value is calculated implicitly by the image's 1212 position 1220 within the image collection 1210.

Visual distance 1230 represents a positional difference between a given image 1212 within the image collection 1210 and a visible image 1214. A smaller “distance” implies that a likelihood of that image 1212 becoming visible is greater than a likelihood of an image with a larger “distance” from the visible image 1214. An example workflow scenario is that as a user scrolls through a collection of images, the image adjacent to the current visible image will tend to be encountered before non-adjacent images.

For example, as also shown in FIG. 12, display arrangement or “glass” 0, 1, and 2 provide arrangements of displayed or “visible” images as well as invisible collections associated with those displayed images.

Visibility is an indication of whether an image is currently visible on the glass. Actual image visibility can be overridden at least partially by the visibility or glass number of the collection as shown in the example of FIG. 12.

Given an order of glass zero 1240, glass one 1242, and glass two 1244 and an arrangement of images 1-12 within the glasses 1240, 1242, 1244, their priority for processing a display. For example, the LVS 1200 calculates a priority for images on each glass based on a visual distance (e.g., how far the image is from the visible image), position (e.g., serial, sequence, or reference number), and image collection. A processing server can recalculate priority based on a change in visible image without sending any other information (e.g., quicker, with less lag), for example.

As shown in FIG. 12, based on priority, a first “glass” 1240 or set of images (e.g., a set of four images in a four blocker) can be provided, and, while the first glass 1240 is being displayed, a next glass 1242 is loaded, and so on.

For example, in FIG. 12, there are twelve image collections. At any given time, only four of the image collections are actually displayed on the glass. Currently, Glass 0 (Image Collections 1 thru 4) is displayed. If the user selects “Next Hanging Protocol”, the next four image collections would be displayed (Glass 1—Image Collections 5 through 8). After selecting again, Glass 2 (Image Collections 9 thru 12) would be displayed. Glass order dictates that Image Collections 1 thru 4 are loaded according to a requested quality of the Image Collection before loading the next glass index. While image collections 5 through 12 have an image set to ‘visible’, the glass number and visibility status of their Image Collection override this state. For all Image Collection Glass Number being equal, Image Collections 5 through 12 would load concurrently in similar fashion to the rows above corresponding to Image Collections 5 through 8, for example.

The quality to which an image is to be loaded is inherited from its parent image collection. In some cases, however, a single image or subset of images within an image collection must be loaded to full quality (high-bit overlays, DSA reference frames, etc.), while the remaining images in the collection are loaded to the collection's default quality.

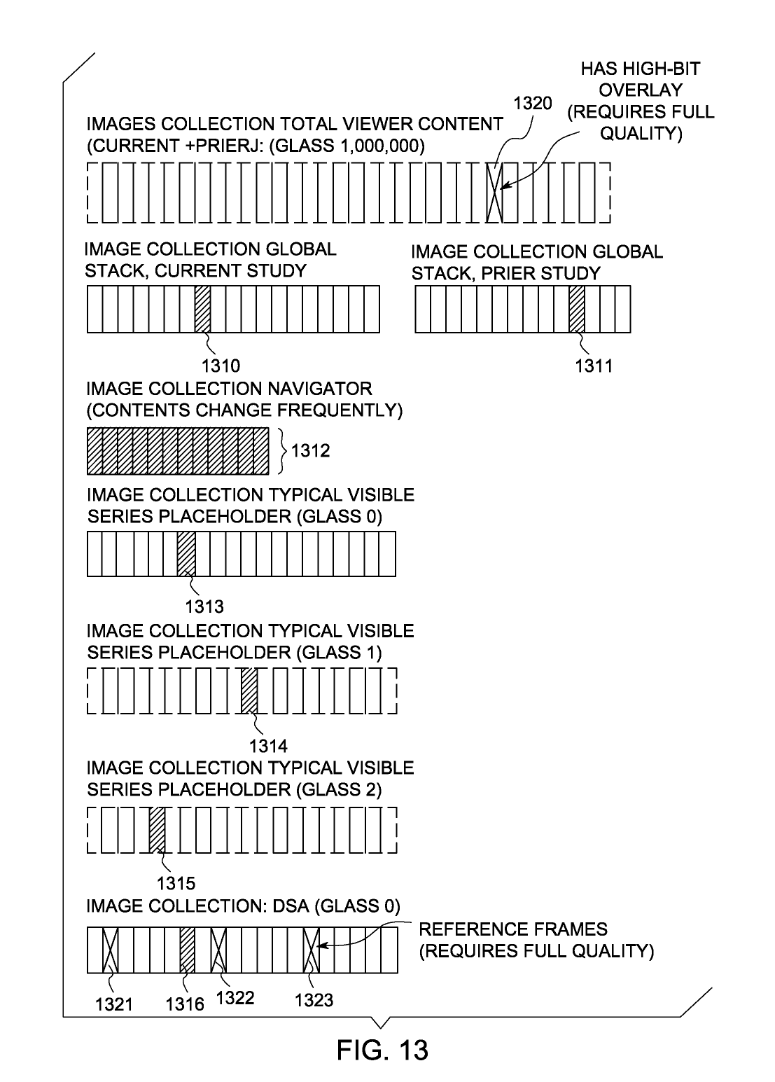

FIG. 13 provides further examples of image priority based on context, study, collection, etc. As shown in FIG. 13, a plurality of images are processed according to currently visible images 1310-1316 and images 1320-1323 required at full image quality, rather than lossy quality, for example. In the example of FIG. 13, image collections with a solid border are currently visible, while image collections with a dashed board are currently “invisible”.

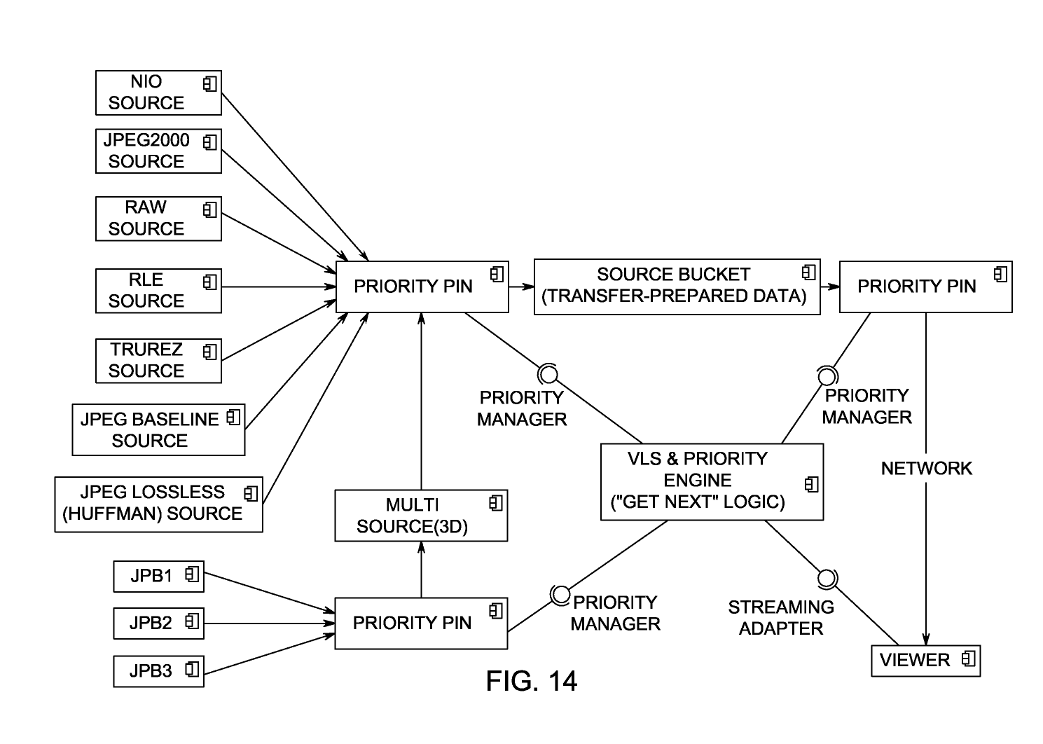

FIG. 14 depicts an example architecture including a plurality of image data sources, input pins, LVS and priority engine, and viewer for image input, processing, prioritization, and output. As discussed above, certain examples provide a data priority mechanism (e.g., pipeline) through which a low quality image (e.g., 10 k of 100 k for each image) is first sent, and sending of one image is interrupted if the user switches to viewing another image. Image(s) already farther down the pipeline still follow priority rules regardless of how much data may have already been downloaded, for example.

In certain examples, a priority engine talks to pins and finds pins with a highest priority and tells those pins or data inputs to send a chunk of their data. Using one or more priority managers and streaming adapters, a prioritized flow of data is established through the pipeline, and where the data is flowing next depends on a global priority object. Priority can change regardless of where the previous priority data was in the pipeline. Based on source, priority, and processing, image data can be streamed to a viewer for image display and manipulation, for example.

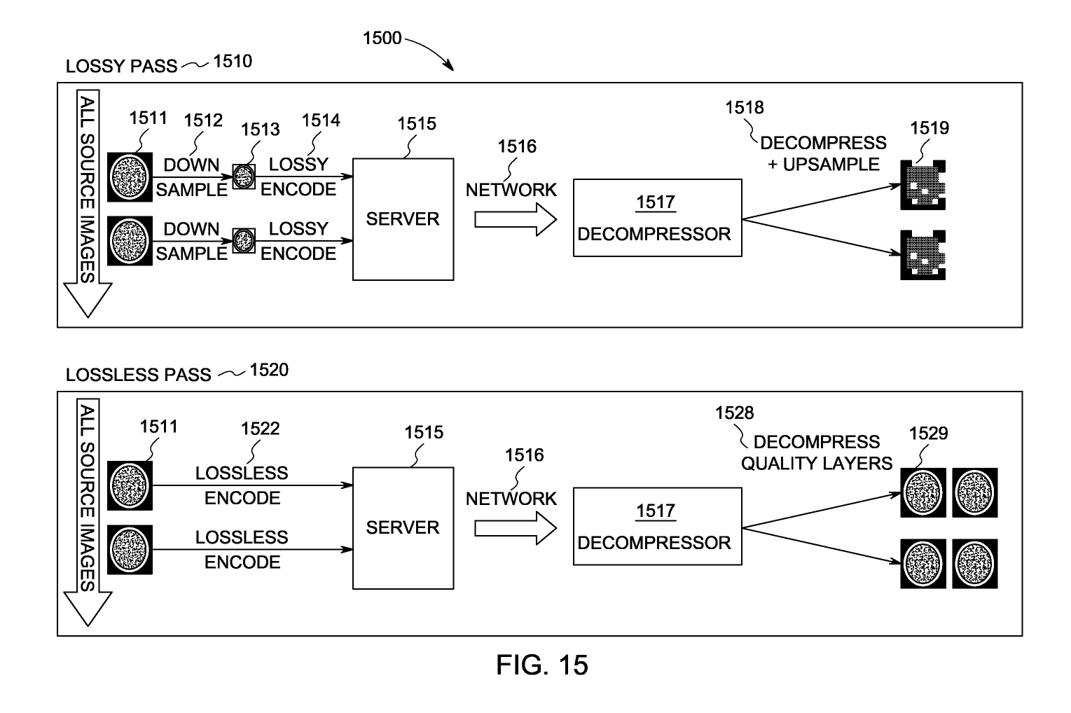

FIG. 15 illustrates an example multi-pass data flow 1500 using fast lossy JPEG2000 compression to generate a lossy pre-image to send first. That image is then followed by one or more lossless images. In certain examples, a low quality first image can be provided for an entire stack or can be interrupted with a user request for high-quality image(s). In certain examples, the fast lossy process can be abstracted to multiple passes.

In certain examples, two-pass compression allows for navigational quality images quickly, and can be tuned to the modality or to a quality metric. Two-pass compression uses additional bandwidth but, due to a scalable image codec, extra data being sent can be controlled. In certain examples, if lossy is not needed or desired, the system can compress and send lossless imagery.

As illustrated in the example of FIG. 15, a lossy pass 1510 for one or more source images 1511 provides image down-sampling 1512 to produce down-sampled images 1513, which are encoded with lossy encoding 1514 and provided to a server 1515. The server 1515 transmits the lossy encoded, down-sampled images over a network 1516 to a decompressor 1517 (e.g., at a viewer, client, etc.), which decompresses and upsamples 1518 the lossy encoded, downsampled images to provide images 1519. Such images 1519 can be used for initial display via a viewer, for example.

Then, in a lossless pass 1520, the one or more source images 1511 are losslessly encoded 1522 and sent to the server 1515, which transmits them over the network 1516 to the decompressor 1517. The decompressor 1517 decompresses quality layers 1528 in the lossless encoded images and provides the resulting images 1529 for higher quality diagnostic viewing, for example.

Thus, certain examples provide good visual quality navigational images rapidly with simple implementation, and lossy image quality can be controlled.

Pipeline Construction

In certain examples, pipeline construction is performed in parallel to the data flow through the pipeline by a filter graph's “Pipeline Construction Robot”. Pipelines are constructed incrementally in an upstream to downstream (e.g., source to renderer) direction. Data may flow through the upstream components immediately from the time when a component (e.g., filter or pin) is added to the graph and connected to its upstream filter.

In certain examples, pipeline path construction (e.g., creation of filters and connecting their pins) occurs when a new image or non-image objects is requested for render. Pipeline path construction also occurs when an outside-pipeline event occurs, such as a DICOM file completed parsing, thus supplying the information to create the source filter (e.g., offset within DICOM file of pixel data). Pipeline path construction also occurs when information within a filter execution clarifies unknown information to determine which filter components are to be used to continue the pipeline path to the renderer (e.g., a multi-component Jpeg 2000 image, when the number of components are unknown before reading the file from disk by the source filter, etc.).

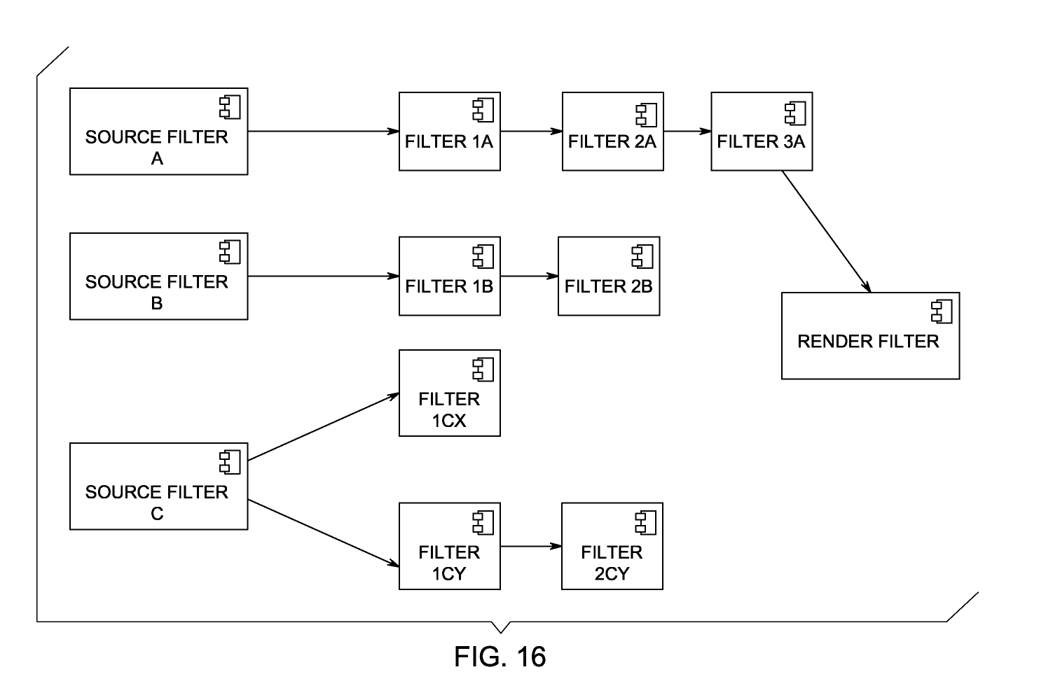

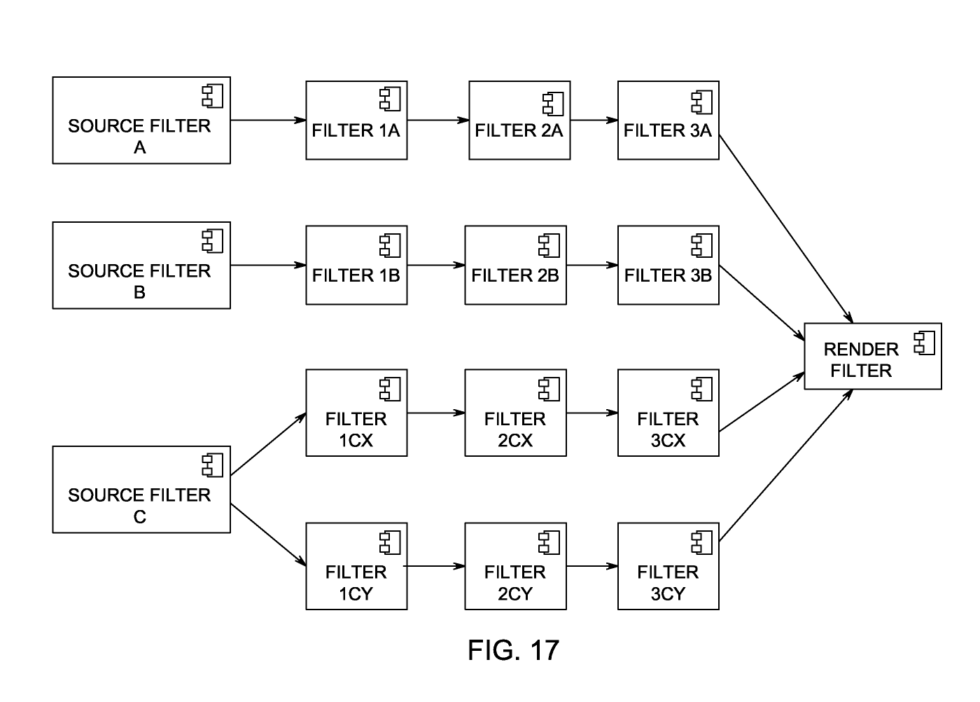

As illustrated in the example of FIG. 16, the pipeline construction robot has a partially constructed pipeline, with data flowing through all upstream-connected filters. FIG. 17 depicts a fully constructed pipeline and data flow of image data from source filters to render filter.

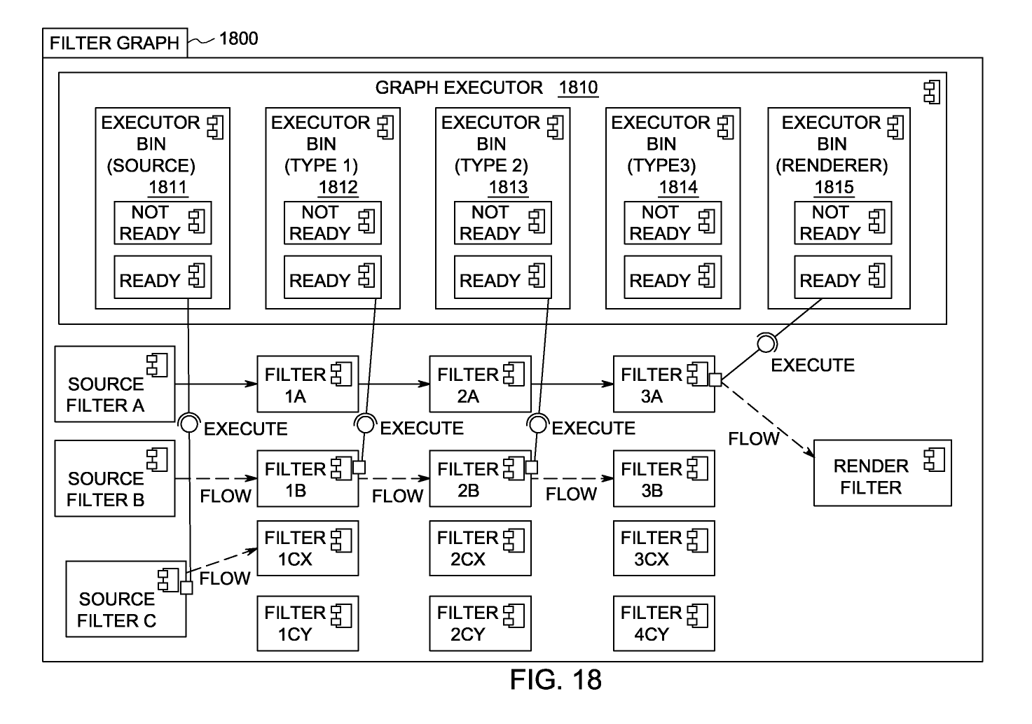

As shown in the example filter graph 1800 of FIG. 18, in addition to pipeline components, the filter graph also includes a graph executor 1810. The graph executor 1810 includes executor bins 1811-1815, which in turn, have one or more executor threads associated with each executor bin 1811-1815.

A “prioritized thread” is a worker thread that is assigned by the graph executor 1810 to a particular executor bin 1811-1815. The prioritized thread queries the executor bin 1811-1815 for its highest-priority non-busy object and subsequently calls that object's “execute” method. If the execute method returns a false value, for example, the object is assumed to have completed its lifetime purpose for that particular bin and is removed from the bin. If the execute method returns an error condition (e.g., anything else except an okay message/value), the thread notifies the filter graph 1800 that the object in question has encountered an error, and this error is propagated to a renderer by the filter graph's command-processing thread. If the execute method returns an okay value/message, then the thread continues and queries the executor bin 1811-1815 again for the highest-priority prioritized object, calls the execute method on that object, etc.

Prioritized objects are objects within the pipeline which export (among other methods) an “execute” method, which causes the object to push data upstream through the pipeline. In a most normal case, prioritized objects tend to be the output pins of the filter objects, although in some cases they are the filters themselves, or even external objects to the pipeline connection scheme (e.g., DICOM parser objects, which are to be executed to obtain information to select pipeline components for pipeline building). This “execute” method takes, as a parameter, a type of bin which is performing the execution, for example.

An executor bin includes a set of prioritized object pointers which are included within one of two following sub-bins:

1. Not-Ready Sub-Bin: includes prioritized objects which cannot be immediately executed because they:
a. Have not yet received any data from the upstream filter
b. Have processed all of the data sent by the upstream filter and are awaiting more data

When a Prioritized Object has sent all of the data that it expects to send in its lifetime, it returns FALSE from its execute method at which time the prioritized thread removes the pointer reference from the bin altogether.

2. Ready Sub-Bin: includes a set of prioritized object pointers which are eligible for execution (having the “execute” method called, presumably to pass data to their downstream-connected pin or to notify the pipeline construction robot of information which it acquired that makes it possible for the robot to continue building the pipeline for a given object or multiple objects (e.g., image and non-image objects)). The bin keeps these pointers in order by priority. The prioritized objects themselves can be in one of two states:
a. Not Busy: This object is available for execution
b. Busy: The object is currently being executed by one of the prioritized threads which are assigned to the prioritized bin and should be ignored when selecting the highest-priority prioritized object to be executed. At any given time, the maximum number of prioritized objects which may be in the “busy” state equals the number of prioritized threads assigned to the prioritized bin. This number is generally relatively small (e.g., 5 or less), and, thus, keeping busy objects in the ready bin and skipping over the busy ones is less computationally expensive than removing them from the bin during execution and re-inserting them (with priority sorting) after execution.

FIG. 18 provides an example of a graph executor 1810 “pushing” data flow at discreet points within the pipeline on a prioritized basis per bin 1811-1815. For clarity, only one prioritized thread per bin 1811-1815 and non-executing data connections are shown.

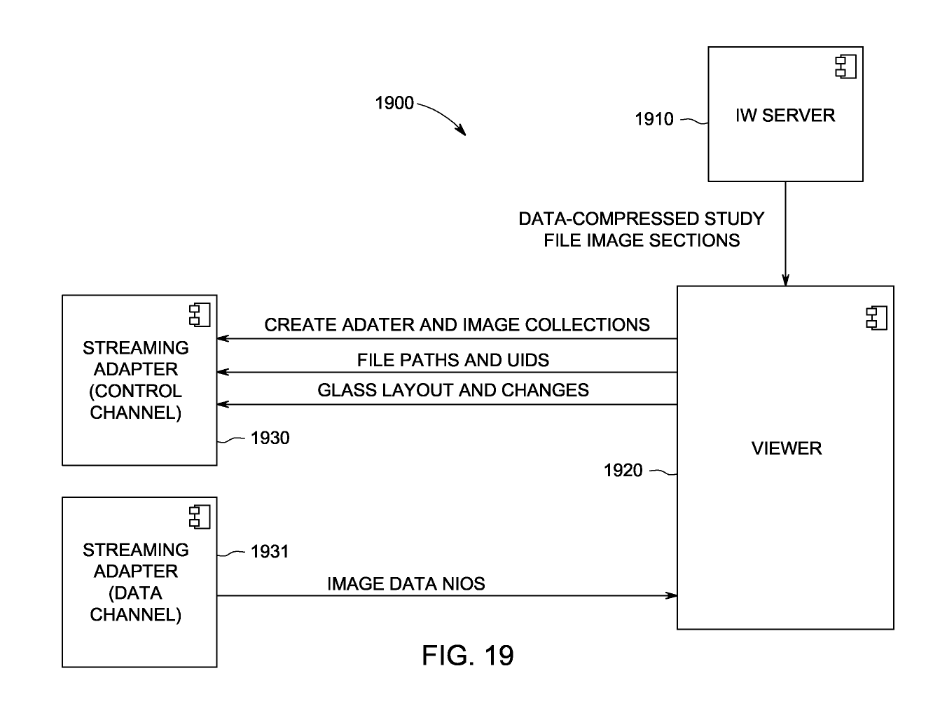

In certain examples, a client adapter's communication with a streaming server occurs on two channels. The first channel is the control channel, which tells the streaming server which images will be required for the current session as well as the state (and changes in state as required) of the viewer glass. This channel is transient—it is opened as needed, commands are sent, and then the channel is closed. The second channel is the data channel. As long as there is bulk data (e.g., image or non-image object (NIO)) on the adapter, this channel remains open in a state of constant read. FIG. 19 illustrates an example system 1900 showing data communication and channels between an IW server 1910, a viewer 1920, and a plurality of streaming adapters 1930-1931 providing a control channel 1930 and a data channel 1931, respectively.

Using the system 1900, the IW server can send a delta-compressed image study and/or one or more file image sections to the viewer 1920. The viewer 1920 sends instruction(s) to create one or more adapter and image collections to the control channel adapter 1930. The viewer 1920 can also send file paths and identifiers, glass layout and change instructions, etc. to the streaming adapter 1930. The data channel streaming adapter 1931 sends resulting image data, non-image objects, etc., to the viewer 1920 for display.

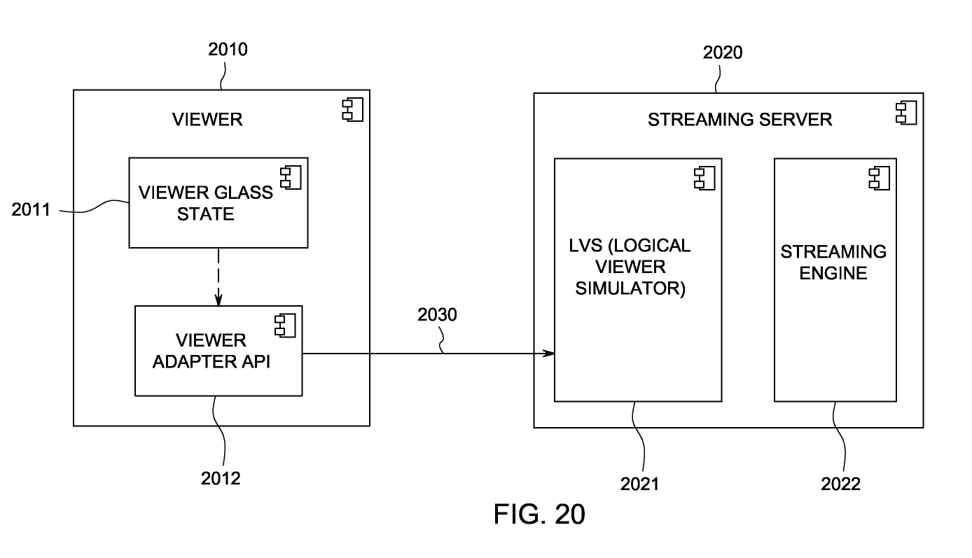

As shown in the example of FIG. 20, a control channel 2030 communicates information from a viewer adapter application programming interface (API) 2012 on a viewer 2010 to a LVS (Logical Viewer Simulator) 2021 on a streaming server 2020. The server 2020 can then reconstruct an instantaneous state of the viewer 2010, viewer glass state 2011, and intentions through a minimal transfer of information once the image collection objects are constructed. In certain examples, the viewer adapter API 2012 results in a fully reversible function of the viewer glass. Output from the LVS 2021 is provided to the streaming engine 2022.

In certain examples, the data channel sends data packets to a client-side viewer adapter. Packets include two parts: 1) a packet header including information to be used by client to route the immediately-following raw data to the proper image or NIO store on the client; and 2) raw data associated with the packet header.

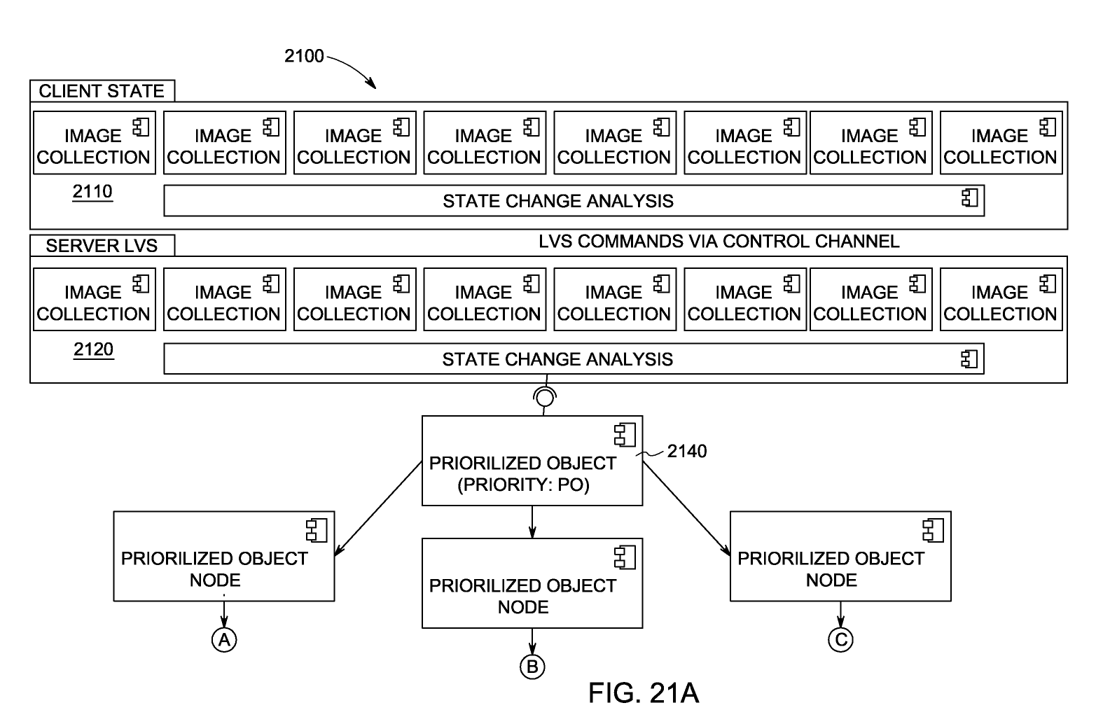

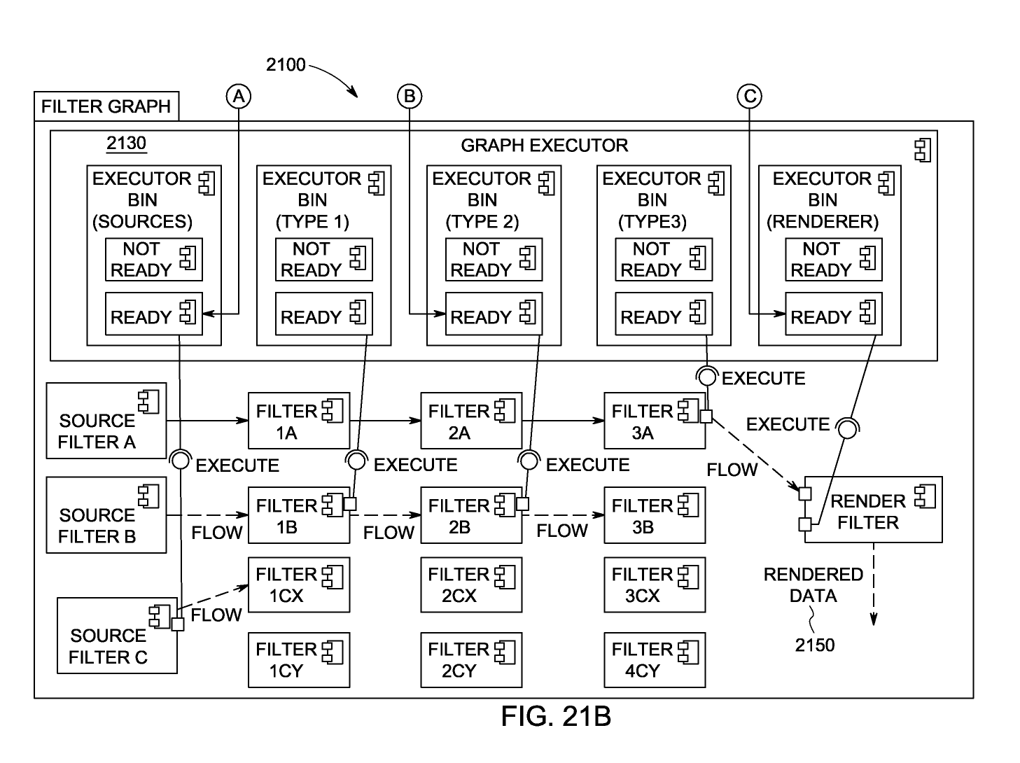

FIG. 21 provides an example of a complete system and flow 2100 of command channel and data. The example system 2100 includes a client state 2110, a server LVS 2120, and a filter graph 2130. One or more prioritized objects 2140 are provided by the LVS server 2120 to the filter graph 2130. By analyzing a state change, the client state 2110 provides one or more LVS commands via control channels to the server 2120. The server similarly performs a state change analysis to provide the one or more prioritized objects 2140 for filtering and output via the filter graph 2130 to provide rendered data 2150 (e.g., to a viewer, browser, etc.).

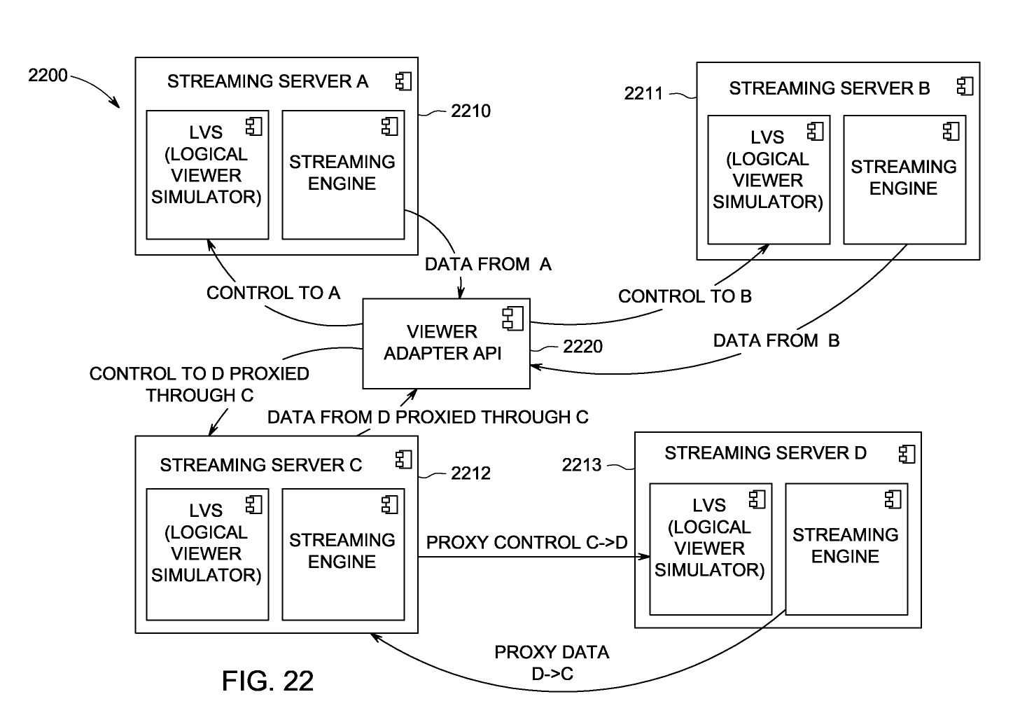

In certain examples, a single adapter instance provides an abstraction of sending control commands to as well as retrieving image and NIO data from multiple streaming servers simultaneously (or substantially simultaneously given some system/communication latency). The streaming server can also act as a proxy for commands and image/NIO data for another streaming server (for example, when the secondary streaming server is located on a network which is not directly accessible from the client). FIG. 22 illustrates an example single viewer adapter instance 2200 with multiple streaming servers 2210-2213. Each streaming server 2210-2213 includes an LVS and a streaming engine. A viewer adapter API 2220 provides control instructions to each streaming server 2210-2213 and receives streaming data from each server 2210-2213. As shown in the example of FIG. 22, a streaming server 2212 can serve as a proxy for another streaming server 2213, providing proxy control messages to the server 2213 and receiving proxy data from the server 2213 for output.

In certain examples a viewer adapter (e.g., viewer adapter 2220 represents a logical context of a viewer process. From this adapter, image collections are created, which represent specific image transfer needs of the process. The adapter itself has a single property representing its global priority.

Global priority represents an image-transfer priority between multiple processes on the same workstation. Global priority can also be extended to handle load-balancing between multiple workstations (e.g., reading radiologists should get their images at a higher priority than referring physicians, etc.).

In Auto-Fetch mode, for example, several viewers are launched simultaneously (five is a common number). The use case is that a doctor intends to read his entire worklist of studies, so he will click on the first one and start to read the first study. In the background, several other viewers (in this case, four) will automatically launch and load the next four studies in the background while the doctor reads the first study. When he finishes the first study, he clicks Next, and the next viewer becomes active, presumably with all of its images already loaded. At any time during reading, the doctor may click on a different viewer on the task bar and make that one become active.

In certain examples, an active viewer should get its images first, while background images should not start to download their images. This should happen in the background, in order, but may be preempted by user intervention (e.g., user closing the current study before its load completes, or clicking on the task bar and making a different viewer active, etc.).

In certain examples, images are represented by location attributes. These attributes include a server to be contacted for retrieval as well as a proxy address (if necessary), a file name (possibly with offset and length for concatenated files), and a frame number within the pixel data itself (for multi-frames). This token can be used to uniquely identify an image internally within the viewer adapter, for example.

An image collection represents an arbitrary collection of images which are related to each other in some way, such as “eventually need to be loaded by the process”, “part of the same study”, “in the same view”, “key images”, etc. Images can be added, removed, replaced, and/or otherwise reordered in an image collection, for example.

An image collection can have a variety of states representing their relationship to the viewer glass, or some other abstract loading requirement (e.g., Cedara, or CD-Film server never appear on any “glass”, although they have different loading requirements).

In many cases, an image collection maps directly to a viewport that is currently on the “glass, or has some probability of being on the glass at some point in the future. Generally, there will also be a baseline image collection which includes an entire viewer context (all images to be loaded by the viewer or other application, such as CD-Film.

Within an image collection, individual images generally inherit their properties from a state of the image collection itself along with the additional priorities calculated by their position within the image collection relative to visible images within the image collection:

Serial number represents the order of an image within an image collection. In certain examples, this is the lowest priority modifier of an image. An example workflow scenario is that for all other priority-affecting parameters being equal, images should tend to load in a fashion from beginning-to-end within an image collection (be it partial quality pass or a cine pass, for example). This value is calculated implicitly by the image's position within the image collection, for example.

Visual distance represents the positional difference between a given image within an image collection and a visible image. A smaller “distance” implies that a likelihood of that image becoming visible is greater than the likelihood of an image with a larger “distance”. An example workflow scenario for this is that as a user scrolls through a collection of images, the image adjacent to the current visible image will tend to be encountered before non-adjacent images.

Visibility is simply an indication of whether an image is currently visible on the glass. Actual image visibility can be overridden partially by the visibility or glass number of the collection.

In an example, there are twelve image collections. At any given time, only four of these are actually displayed on the glass. Currently, Glass 0 (Image Collections 1 thru 4) is displayed. If the user were to select “Next Hanging Protocol”, the next four would be displayed (Glass 1—Image Collections 5 thru 8) and then after selecting again, finally Glass 2 (Image Collections 9 thru 12). Glass order dictates that Image Collections 1 through 4 are loaded to the requested quality of the image collection before loading the next glass index. While image collections 5 through 12 have an image set to ‘visible’, the glass number and visibility status of their image collection override this state, causing a change in their order.

In certain examples, a quality to which an image is to be loaded is inherited from its parent image collection. In some cases, however, a single image or subset of images within an image collection must be loaded to full quality (e.g., high-bit overlays, DSA reference frames, etc.), while the remaining images in the collection are loaded to the collection's default quality.

As images are available either for the first time or at increased quality, the adapter notifies the application of this change. This callback is at the adapter-level and specifies the image ID and an indication of the quality reached.

It should be understood by any experienced in the art that the inventive elements, inventive paradigms and inventive methods are represented by certain exemplary embodiments only. However, the actual scope of the invention and its inventive elements extends far beyond selected embodiments and should be considered separately in the context of wide arena of the development, engineering, vending, service and support of the wide variety of information and computerized systems with special accent to sophisticated systems of high load and/or high throughput and/or high performance and/or distributed and/or federated and/or multi-specialty nature.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A medical image streaming pipeline system, the system comprising:
a streaming engine, the streaming engine configured to receive a request for image data, and, according to a data priority determination, extract the requested image data from a data storage and process the image data to provide processed image data for display,
wherein the streaming engine is to process the image data to generate, based on downsampling, lossy encoding, decompression and upsampling, a first lossy pre-image for initial display and then to generate, based on lossless encoding and decompression, a lossless image for diagnostic display.

2. The system of claim 1, wherein the streaming engine comprises a componentized pipeline architecture to process and filter a plurality of image pixel data to provide a rendered image for display.

3. The system of claim 2, wherein the pipeline is dynamically extendable based on image data and priority using an interface dynamically relating input and output pins to filter components.

4. The system of claim 1, wherein the streaming engine further comprises a plurality of filter stages organized according to a filter graph and including a graph executor to coordinate execution to process image data.

5. The system of claim 1, wherein the streaming engine comprises a logical viewer simulator to calculate image priority for processing

6. The system of claim 5, wherein the logical viewer simulator is to calculate priority based at least in part on image position in a collection of images and visual distance from a currently visible image.

7. The system of claim 1, further comprising a control channel to exchange messages and a data channel to provide image data.

8. The system of claim 1, further comprising a plurality of streaming engines communicating with a plurality of data storage and one or more viewers to display resulting images.

9. A tangible computer readable storage medium including computer program instructions to be executed by a processor, the instructions, when executing, to implement a medical image streaming engine, the streaming engine configured to:
receive a request for image data;
according to a data priority determination, extract the requested image data from a data storage; and
process the image data to provide processed image data for display,
wherein the streaming engine is to process the image data to generate, based on downsampling, lossy encoding, decompression and upsampling, a first lossy pre-image for initial display and then to generate, based on lossless encoding and decompression, a lossless image for diagnostic display.

10. The computer readable storage medium of claim 9, wherein the streaming engine comprises a componentized pipeline architecture to process and filter a plurality of image pixel data to provide a rendered image for display.

11. The computer readable storage medium of claim 10, wherein the pipeline is dynamically extendable based on image data and priority using an interface dynamically relating input and output pins to filter components.

12. The computer readable storage medium of claim 9, wherein the streaming engine further comprises a plurality of filter stages organized according to a filter graph and including a graph executor to coordinate execution to process image data.

13. The computer readable storage medium of claim 9, wherein the streaming engine comprises a logical viewer simulator to calculate image priority for processing

14. The computer readable storage medium of claim 13, wherein the logical viewer simulator is to calculate priority based at least in part on image position in a collection of images and visual distance from a currently visible image.

15. A method of medical image streaming, the method comprising:
receiving a request for image data at a streaming engine;
according to a data priority determination, extracting, via the streaming engine, the requested image data from a data storage; and
processing the image data, via the streaming engine, to provide processed image data for display,
wherein the processing comprises processing the image data to generate, based on downsampling, lossy encoding, decompression and upsampling, a first lossy pre-image for initial display and then to generate, based on lossless encoding and decompression, a lossless image for diagnostic display.

16. The method of claim 15, wherein the streaming engine comprises a componentized pipeline architecture to process and filter a plurality of image pixel data to provide a rendered image for display.

17. The method of claim 16, further comprising dynamically extending the pipeline based on image data and priority using an interface dynamically relating input and output pins to filter components.

18. The method of claim 15, wherein the streaming engine further comprises a plurality of filter stages organized according to a filter graph and including a graph executor to coordinate execution to process image data.

19. The method of claim 15, further comprising calculating, using a logical viewer simulator, an image priority for processing

20. The method of claim 19, wherein calculating further comprises calculating priority based at least in part on image position in a collection of images and visual distance from a currently visible image.
